(19) United States
(12) Patent Application Publication
(10) Pub. No.: US 2024/0338631 A1
(43) Pub. Date: Oct. 10, 2024

(54) AI DRIVEN IMPACT ESTIMATION OF NEW PRODUCT FEATURES

(71) Applicant: KYNDRYL, INC., New York, NY (US)

(72) Inventors: Mouleswara Reddy Chintakunta, Allagadda (IN); MANISH MITRUKA, Pune (IN); ANAND BANDARU, Karnataka State (IN); Omar Odibat, Cedar Park, TX (US)

(21) Appl. No.: 18/297,127

(22) Filed: Apr. 7, 2023

(51) Int. Cl. G06Q 10/0637

(52) U.S. Cl. CPC G06Q 10/06375

(57) ABSTRACT

A method for product release estimates a ROI of a new product feature of a product. The method identifies a product component which undergoes change with weightage responsive to epic details and non-functional requirements. The method classifies a component action to provide an action classification. The method calculates an effort to create the new feature responsive to the action and a complexity classification determined from at least the weightage. The method calculates an interval of effort to produce the new product feature responsive to the effort and similar epic matches relating to the new product feature. The method calculates an estimated public release time of the new feature responsive to the similar epic matches relating to the new feature. The method generates and follows a schedule responsive to the effort, the interval of effort, the estimated public release time, and the ROI to make the product having the new feature.

### BACKGROUND

The present invention generally relates to Artificial Intelligence (AI), and more particularly to AI driven systems and methods that employ Return On Investment (ROI) estimation, system impact estimation and effort estimation for introduction of new product features.

A product feature is a function or service that is normally added to the product based on customer requirements and a product roadmap. A new feature launch depends on user needs, revenue impact and competitor research done by a product team. Prioritizing features is difficult for the product team at scale using manual analysis. Estimating the ROI for each feature becomes especially difficult when feature importance and prioritization are needed. User specific feature releases depend on their usage in a product. A need exists for identifying which product components undergo a change and related effort and dependencies to accelerate initial planning and deployment processes of new product features.

### SUMMARY

According to aspects of the present invention, a computer-implemented method for product feature release is provided. The method includes estimating a Return On Investment (ROI) of a new product feature of a product. The method further includes identifying a component of the product which undergoes change with weightage responsive to epic details and non-functional requirements relating to the new product feature. The method also includes classifying, from a set of potential actions including action types, an action of the component to provide an action classification for the component. The method additionally includes calculating an effort to create the new product feature responsive to the action classification and a complexity classification determined from at least the weightage. The method further includes calculating an interval of effort measured in time units to produce the new product feature responsive to the effort and similar epic matches relating to the new product feature. The method also includes calculating an estimated public release time of the new product feature responsive to the similar epic matches relating to the new product feature. The method additionally includes generating and following a manufacturing and release schedule responsive to the effort, the interval of effort, the estimated public release time, and the ROI to make the product having the new product feature in accordance therewith.

According to other aspects of the present invention, a computer program product for product feature release is provided. The computer program product includes a computer readable storage medium having program instructions embodied therewith. The program instructions are executable by a computer to cause the computer to perform a method. The method includes estimating, by a hardware processor of the computer, a Return On Investment (ROI) of a new product feature of a product. The method further includes identifying, by the hardware processor, a component of the product which undergoes change with weightage responsive to epic details and non-functional requirements relating to the new product feature. The method also includes classifying, by the hardware processor from a set of potential actions including action types, an action of the component to provide an action classification for the component. The method additionally includes calculating, by the hardware processor, an effort to create the new product feature responsive to the action classification and a complexity classification determined from at least the weightage. The method further includes calculating, by the hardware processor, an interval of effort measured in time units to produce the new product feature responsive to the effort and similar epic matches relating to the new product feature. The method also includes calculating, by the hardware processor, an estimated public release time of the new product feature responsive to the similar epic matches relating to the new product feature. The method additionally includes generating and following, by a manufacturing and product release system, a manufacturing and release schedule responsive to the effort, the interval of effort, the estimated public release time, and the ROI to make the product having the new product feature in accordance therewith.

According to still other aspects of the present invention, a computer processing system for product feature release is provided. The computer processing system includes a memory device for storing program code. The computer processing system further includes a hardware processor operatively coupled to the memory device for running the program code to estimate a Return On Investment (ROI) of a new product feature of a product. The hardware processor further runs the program code to identify a component of the product which undergoes change with weightage responsive to epic details and non-functional requirements relating to the new product feature. The hardware processor also runs the program code to classify, from a set of potential actions including action types, an action of the component to provide an action classification for the component. The hardware processor additionally runs the program code to calculate an effort to create the new product feature responsive to the action classification and a complexity classification determined from at least the weightage. The hardware processor further runs the program code to calculate an interval of effort measured in time units to produce the new product feature responsive to the effort and similar epic matches relating to the new product feature. The hardware processor also runs the program code to calculate an estimated public release time of the new product feature responsive to the similar epic matches relating to the new product feature. The hardware processor additionally runs the program code to generate and follow a manufacturing and release schedule responsive to the effort, the interval of effort, the estimated public release time, and the ROI to make the product having the new product feature in accordance therewith.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 is a block diagram showing an exemplary computing device, in accordance with an embodiment of the present invention;

FIG. 2 is a block diagram showing a first portion of an exemplary system, in accordance with an embodiment of the present invention;

FIG. 3 is a block diagram showing a second portion of an exemplary system, in accordance with an embodiment of the present invention;

FIG. 4 is a block diagram showing a third portion of an exemplary system, in accordance with an embodiment of the present invention;

FIGS. 5-7 are flow diagrams showing an exemplary method for estimating an impact of a feature addition or change, in accordance with an embodiment of the present invention;

FIG. 8 is a block diagram showing an exemplary first method for estimating a Return On Investment (ROI) of a feature, in accordance with an embodiment of the present invention;

FIG. 9 is a block diagram showing an exemplary second method for estimating a ROI of a feature, in accordance with an embodiment of the present invention;

FIG. 10 is a block diagram further showing an effort regressor of FIG. 3, in accordance with an embodiment of the present invention;

FIG. 11 is a block diagram further showing a release estimator of FIG. 4, in accordance with an embodiment of the present invention;

FIG. 12 is a block diagram further showing a similar epics matcher of FIG. 3, in accordance with an embodiment of the present invention;

FIG. 13 is a block diagram showing a system and method for Non-Functional Requirement (NFR) detection, in accordance with an embodiment of the present invention; and

FIG. 14 is a block diagram showing an exemplary environment to which the present invention can be applied, in accordance with an embodiment of the present invention.

### DETAILED DESCRIPTION

Embodiments of the present invention are directed to Artificial Intelligence (AI) driven impact estimation of new product features. Embodiments of the present invention are directed to estimating a Return On Investment (ROI), an amount of effort, scheduling delays and a release interval return for new product features. Features or services can be any type of add-on, replacement, deletion or modification to a product. As an example, a product can include a software program and the feature can include but is not limited to a new input field, output field, drop down, switch, button, etc. that can be added to a dashboard or other interface. New features can be determined based on customer feedback, the need for upgrades or any other circumstance. Changing a feature in a complex software system can have cascading impacts. For example, adding a power on/off switch to a dashboard will affect at least a user interface component, a data component, application programming interface (API) layer as well as other components.

In accordance with embodiments of the present invention, systems and methods are provided to enable the determination of the impact for changing or adding a new feature to a program or tool. Once the impact is determined, the impact can be employed for comparisons of different feature scenarios for a same item, a competing item, different items or combinations of these and other considerations. The systems and methods can be employed to determine priorities on changes (what should be performed and in what order), viability of changes (should the feature even be added or modified) and costs associated with these changes. While the present embodiments will be described in terms of illustrative examples, the present system and methods can be employed in any number of fields of endeavor, e.g., in e-commerce applications, product development applications, manufacturing applications, web design applications and so on. The present embodiments can also be employed to assist in decision making and prioritization in a manufacturing environment for any product or service, planning for any product or service or any other task-driven hierarchy projects including but not limited to epic methods or the like.

In particularly useful embodiments, systems and computer-implemented methods for product feature release include estimating a Return On Investment (ROI) of a new product feature of a product. A component of the product which undergoes change is identified with its weightage responsive to epic details and non-functional requirements relating to the new product feature. From a set of potential actions including action types related to the features under consideration, an action of the component is classified to provide an action classification for the component (e.g., add, replace, etc.). An effort needed to create the new product feature is determined responsive to the action classification and a complexity classification, which can be determined from at least the weightage.

An interval of effort is measured (e.g., in time units) to produce the new product feature responsive to the effort and similar epic matches relating to the new product feature. An estimated public release time of the new product feature is computed responsive to the similar epic matches relating to the new product feature. A manufacturing and release schedule can be generated and followed responsive to the effort, the interval of effort, the estimated public release time, and the ROI to make the product having the new product feature.

Embodiments of the present invention can identify components which undergo change and associated efforts to speed up deployment processes and decision making. In an embodiment, a feature release estimator is provided to determine an amount of time needed for feature creation and release of a product or feature. In one embodiment, a similar epics matcher can be employed to calculate the elapsed time and effort needed to produce similar features.

A non-functional requirement detector can be employed to capture all non-functional requirements for new product features. Embodiments of the present invention can determine a manufacturing and release (delivery) schedule that is adhered to by a manufacturing system. Manufacturing systems can include any fabrication system related to the building or implementation of the product feature.

Embodiments of the present invention can provide a scalable and cost-effective solution for offerings with a large and diverse set of customers with rapid innovation and changes in the marketplace and competitive landscape. Embodiments of the present invention can add automation to the current manual and subjective feature request analysis and prioritization process and make the automation process data driven.

Embodiments of the present invention can reduce the elapsed time and skill requirements in the initial sizing and analysis of a feature requirement. Embodiments of the present invention reduce the duplication of feature and functions across multiple offerings and products by discovery of existing features and components and can improve the feature requests with details about non-functional requirements and factor them into the estimation and ROI calculation process so the feature delivery is as per customer expectation and scale.

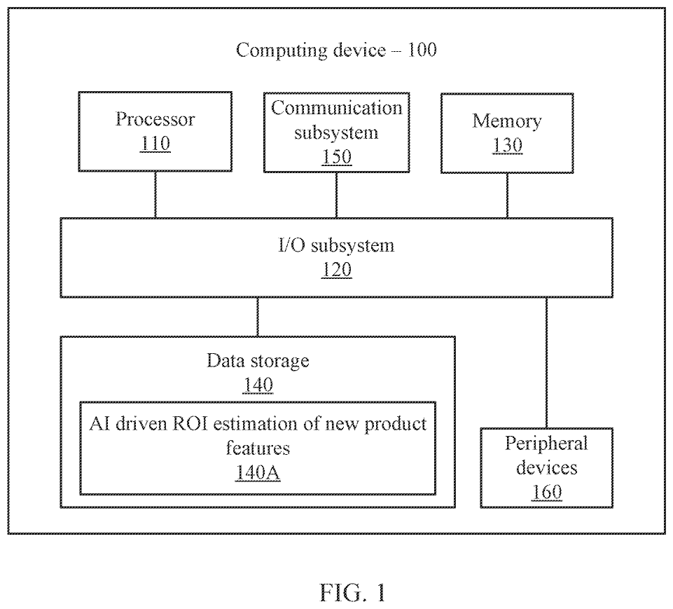

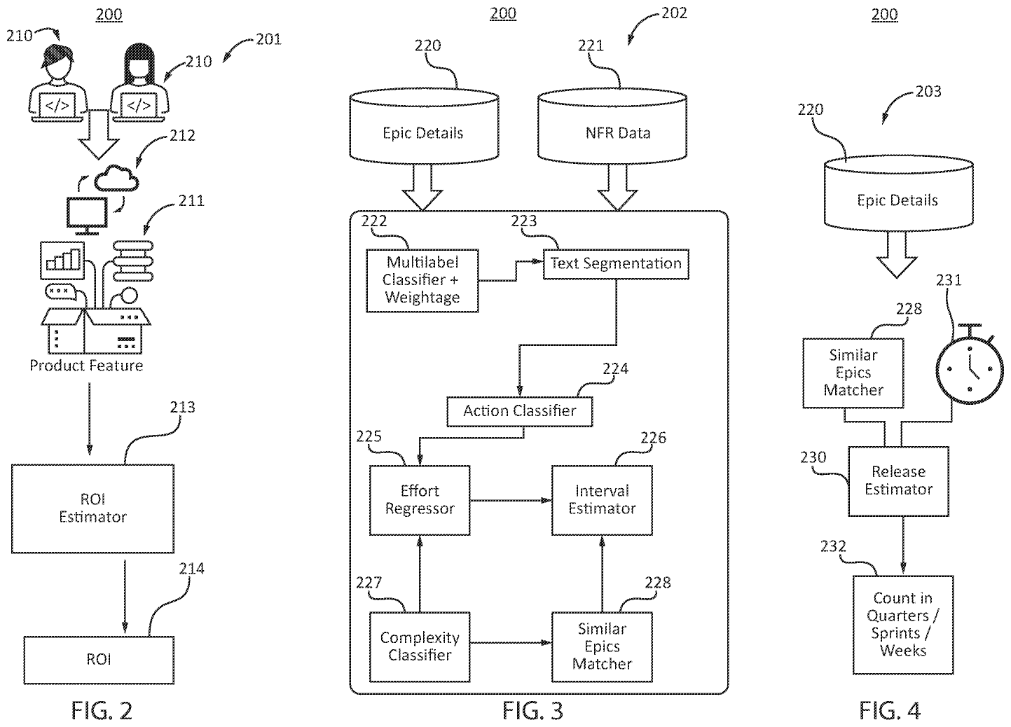

FIG. 1 is a block diagram showing an exemplary computing device 100, in accordance with an embodiment of the present invention. The computing device 100 is configured to execute AI driven ROI and impact estimation program 140A for new product features, which can be stored in a data storage device 140. Computing device 100 can work in conjunction with program 140A to implement portions 201, 202, and/or 203 as described with respect to FIG. 2.

The computing device 100 may be embodied as any type of computation or computer device capable of performing the functions described herein, including, without limitation, a computer, a server, a rack based server, a blade server, a workstation, a desktop computer, a laptop computer, a notebook computer, a tablet computer, a mobile computing device, a wearable computing device, a network appliance, a web appliance, a distributed computing system, a processor-based system, and/or a consumer electronic device. Additionally or alternatively, the computing device 100 may be embodied as one or more compute sleds, memory sleds, or other racks, sleds, computing chassis, or other components of a physically disaggregated computing device. As shown in FIG. 1, the computing device 100 illustratively includes a processor 110, an input/output (I/O) subsystem 120, a memory 130, the data storage device 140, and a communication subsystem 150, and/or other components and devices commonly found in a server or similar computing device. Of course, the computing device 100 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 130, or portions thereof, may be incorporated in the processor 110 in some embodiments.

The processor 110 may be embodied as any type of processor capable of performing the functions described herein. The processor 110 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 130 may be embodied as any type of volatile or non-volatile memory or data storage capable of performing the functions described herein. In operation, the memory 130 may store various data and software used during operation of the computing device 100, such as operating systems, applications, programs, libraries, and drivers. The memory 130 is communicatively coupled to the processor 110 via the I/O subsystem 120, which may be embodied as circuitry and/or components to facilitate input/output operations with the processor 110 the memory 130, and other components of the computing device 100. For example, the I/O subsystem 120 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.) and/or other components and subsystems to facilitate the input/output operations. In some embodiments, the I/O subsystem 120 may form a portion of a system-on-a-chip (SOC) and be incorporated, along with the processor 110, the memory 130, and other components of the computing device 100, on a single integrated circuit chip.

The data storage device 140 may be embodied as any type of device or devices configured for short-term or long-term storage of data such as, for example, memory devices and circuits, memory cards, hard disk drives, solid state drives, or other data storage devices. The data storage device 140 can store program code for AI driven ROI and impact estimation of new product features. The communication subsystem 150 of the computing device 100 may be embodied as any network interface controller or other communication circuit, device, or collection thereof, capable of enabling communications between the computing device 100 and other remote devices over a network. The communication subsystem 150 may be configured to use any one or more communication technology (e.g., wired or wireless communications) and associated protocols (e.g., Ethernet, InfiniBand®, Bluetooth®, Wi-Fi®, WiMAX, etc.) to affect such communication.

As shown, the computing device 100 may also include one or more peripheral devices 160. The peripheral devices 160 may include any number of additional input/output devices, interface devices, and/or other peripheral devices. For example, in some embodiments, the peripheral devices 160 may include a display, touch screen, graphics circuitry, keyboard, mouse, speaker system, microphone, network interface, and/or other input/output devices, interface devices, and/or peripheral devices.

Of course, the computing device 100 may also include other elements (not shown), as readily contemplated by one of skill in the art, as well as omitting certain elements. For example, various other input devices and/or output devices can be included in computing device 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the computing device 100 are also contemplated in accordance with the teachings of embodiments of the present invention.

As employed herein, the term “hardware processor subsystem” or “hardware processor” can refer to a processor, memory (including RAM, cache(s), and so forth), software (including memory management software) or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor-or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field programmable gate arrays (FPGAs), and/or programmable logic arrays (PLAs).

These and other variations of a hardware processor subsystem are also contemplated in accordance with embodiments of the present invention.

FIGS. 2-4 are block diagrams showing portions of an exemplary system 200 for computing the impact of a change, addition, replacement or deletion of a new product feature or features, in accordance with an embodiment of the present invention.

The system 200 includes three portions, namely a first portion 201 (described with respect to FIG. 2), a second portion 202 (described with respect to FIG. 3), and a third portion 203 (described with respect to FIG. 4).

Referring to FIG. 2, the first portion 201 includes and/or otherwise involves user devices 210, an input specifying one or more product features and related information 211, a server 212, a Return On Investment (ROI) estimator 213, and a ROI 214. The user devices 210 are coupled to the server 212 which, in turn, is coupled to the ROI estimator 213.

After identification of a new product feature using user behavior and other infrastructure details, it is estimated how much ROI can be obtained from this feature and also how much effort is needed to make this product into production. In particularly useful embodiments, customer behavior and information details can include the use of epic details.

Epic is a known methodology employed to assist in the design of new software. Epic details are details related to a task or group of tasks. An epic serves to manage tasks and in a defined body of work. The work is segmented into specific tasks (called “stories,” or “user stories”) based on the needs or requests of customers or end-users. Epics are a helpful way to organize work and to create a hierarchy. Work is broken down into shippable pieces so that large projects can get completed and can continue to ship value to customers on a regular basis. Epics assist teams to break down their work, while continuing to work towards a larger goal. In one embodiment, epic details can include, e.g., a title, a description, and a summary of a new feature or service. Other titled sections can also be employed within epic or without.

Epics can encompass multiple teams, on multiple projects, and can even be tracked on multiple boards or platforms. Epics can be provided over a set of sprints (e.g., a sprint is simply a set duration in time, in which concentrated work will be done on selected stories). As a team learns more about an epic through development and customer feedback, user stories will be added and removed as necessary. This provides flexibility, based on customer feedback and work schedule.

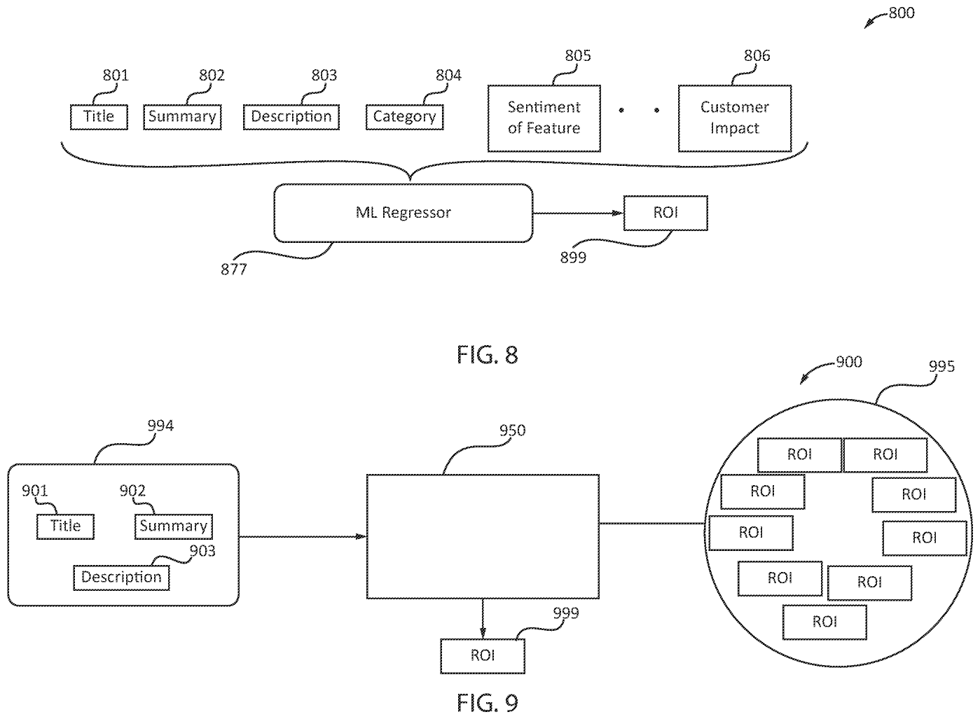

The first portion 201 includes the server 212 configured to receive, from the one or more users 210, the input specifying one or more product features 211. The server 212 outputs the product features 211 to the ROI estimator 213 which outputs the ROI 214 for each of the one or more product features 211. The ROI estimator 213 estimates the ROI for a given feature using a machine learning (ML) driven approach. In an embodiment, the ROI estimator 213 estimates ROI in a multifold first approach where the ROI estimator 213 takes items, e.g., epic details, such as, e.g., title, summary, description, category, sentiment of the feature, and customer impact of all such features and applies a, e.g., ML regressor (877, FIG. 8) or other AI system to calculate ROI. These items can be varied or modified depending on problem set up and available ML models, for example, ML regression may be replaced by other ML methods. ML regressor 877 is described in greater detail with respect to FIG. 8.

Referring to FIG. 3, the second portion 202 includes an epic details store 220, a NFR data detector and store (hereinafter “NFR data store” or “NFR store” in short) 221, a multilabel classifier and weightage element 222, a text segmenter 223 (text segmentation), an action classifier 224, an effort regressor 225, an interval estimator 226, a complexity classifier 227, and a similar epics matcher 228. The epic details store 220 and the NFR data store 221 are coupled to the multilabel classifier and weightage element 222. The multilabel classifier and weightage element 222 is coupled to the text segmenter 223. The text segmenter 223 is coupled to the action classifier 224. The action classifier 224 and the complexity classifier 227 are coupled to the effort regressor 225. The effort regressor 225 and the similar epics matcher 228 are coupled to the interval estimator 226. The epic details store 220 and NFR data are also coupled to the similar epics matcher 228. The epic details store 220 stores epic details.

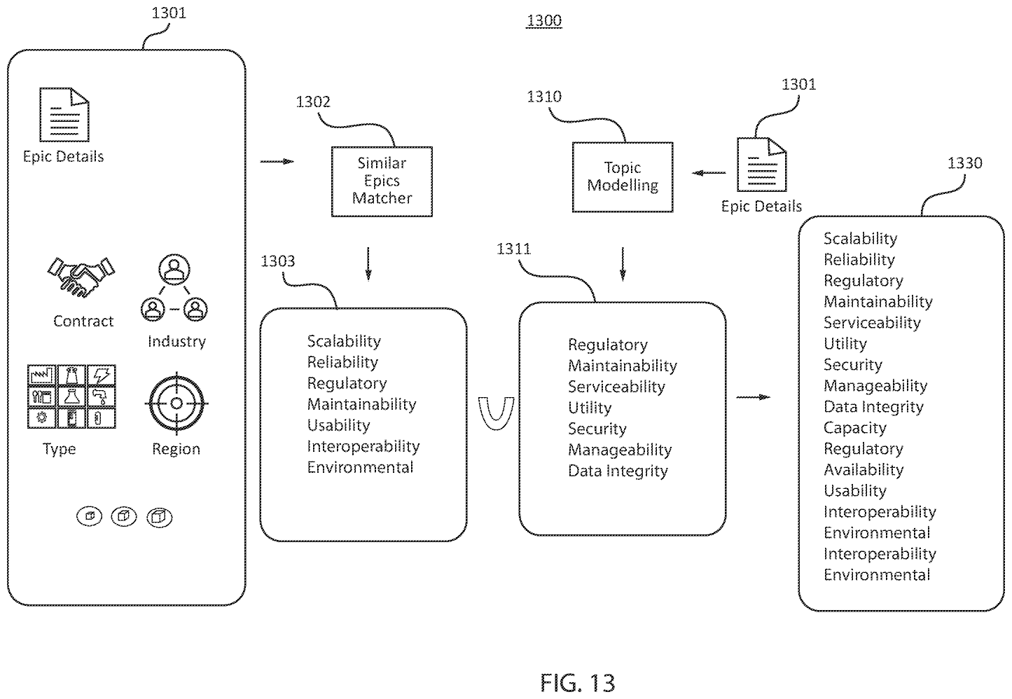

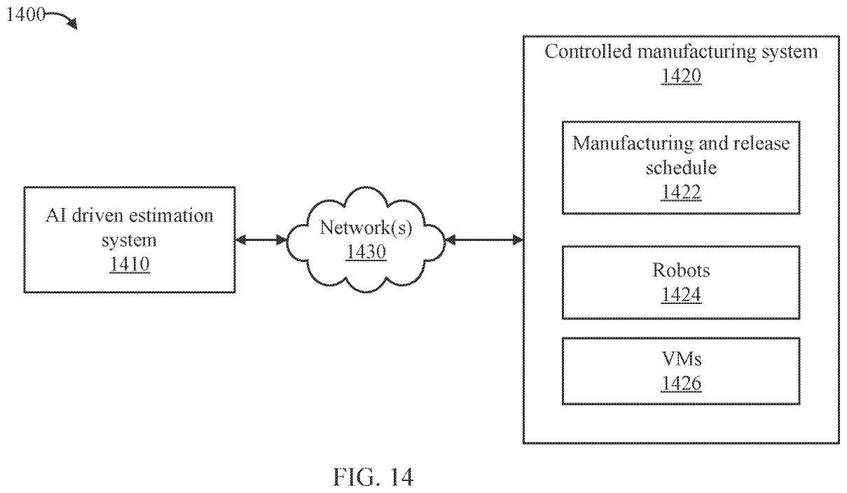

The NFR data store 221 stores non-functional requirements. The non-functional requirements can include labels for a new feature stating whether this new feature needs any security, sustainability, scalability, etc. Further details of non-functional requirements are described with reference to FIG. 13. The non-functional requirements can include a textual information format.

The multilabel classifier and weightage element 222 takes the epic details and the non-functional requirements as input (from the epic details store 220 and the NFR data store 221, respectively) and, in turn, outputs which components (e.g., UI, API layer, ML, Data) undergo change with weightage. Here, weightage is a number from 0 to 1 and represents an estimate of the amount of effort needed to carry out the activity associated with each classified component. The weightage can be determined based on historical data and using machine learning techniques to associate the historical data with a current scenario. Weightage can be assigned or determined based on historical data, project goals, schedule requirements, etc.

The components which undergo change with weightage are provided to text segmenter 223 which collects a group of related text statements from the epic record and/or NFR data for each classified component. The group of related text statements are associated with each other by the text segmenter 223 using AI based language models. So, statements that are related to each component in question, e.g., a UI component, an ML (machine learning process) component, etc. are collected into a group for each feature in question. In particular, the text segmenter 223 segments text in the epic details to associate text statements in a group for each classified component associated with the feature. These groups of text segments are associated with each classified component (including a component label, e.g., UI, API layer, etc.) with the weightage (a number from 0 to 1) for each group.

The groups of text segments for each classified component with weightage are provided to the action classifier 224 to classify which of a number of actions (e.g., four actions) the components undergo (e.g., add, replace, update, delete). The action classifier 224 interprets the collected text segments to determine which action is dominant and assigns that single action to the text segment group. A complexity classifier 227, for each group, uses the action (e.g., add, replace, update, delete), classified component (labeled, e.g., UI, API layer, etc.) and the weightage (a number from 0 to 1) for each group to compute a complexity (e.g., low, medium, and high) associated with the action for that component with weightage. The action and the complexity are provided to the effort regressor 225 to compute an effort (measured in time units) to create a feature. Effort regressor 225 can employ ML techniques to associate historical data with a current scenario to derive an amount of effort needed to implement the action for a given complexity for a given component type and weightage.

It should be understood that classification by the multilabel classifier and weightage 222, action classifier 224 and/or complexity classifier 227 can employ any suitable classification technique, e.g., support vector machine, logistic regression, naive bayes, k-nearest neighbors, decision tree, etc.

The interval estimator 226 takes the input from the effort regressor 225 and similar epics matcher 228 and returns an interval of effort. That is, the interval estimator 226 identifies the amount of interval effort needed to deliver a newly introduced feature characteristic. The similar epics matcher 228 identifies similar epics related to a newly introduced feature. The similar epics matcher 228 employs ML techniques to identify similar records to the interval estimator 226 to derive an estimation range for an amount of effort in time.

Referring to FIG. 4, the third portion 203 includes epic details store 220, similar epics matcher 228, a release estimator 230, and a timer 231.

The epic details store 220 is connected to the similar epics matcher 228. The similar epics matcher 228 and the timer 231 are coupled to the release estimator 230. Timer 231 includes timing or scheduling constraints that can impact the release estimation. An example can include fabrication delays, personnel issues, materials availability. The release estimator 230 returns an estimated release time 232, which provides the time it takes to release the product, e.g., released to the public or to customers, with the feature characteristics under consideration. The estimated release time 232 is provided in units of sprints/weeks/quarters/etc.

In one example application, a product feature needs to be added to a product based on customer requirements and a product roadmap (future product plan). A feature can be a button, a field, a drop down, etc. on a dashboard or other platform that can be, e.g., requested by a customer or added as an improvement. New feature launch can depend on user needs, revenue impact and competitor research done by a product team, among other things.

Here, a ML driven ROI calculation, by ROI estimator 213, is performed to prioritize new candidate features. In one example, a software engineering effort estimation can be performed in accordance with embodiments of the present invention. In an epic methodology, team stories and information are collected as tasks to be performed and planned. This information can include messages between team members, plans, product discussions, descriptions, assumptions, etc. In the epic methodology, epic details are saved and stored. The epic details can share a format or template having a number of useful fields for information (e.g., task title, description, requirements, etc.).

The present system identifies the components to be considered from the epic information (components that undergo or will undergo change) and identifies associated efforts to speed up the deployment process and decision making. In one example, a product change is considered and cost changes are desired to be forecast. The present system employs multilabel classifier and weightage 222 of product team stories to classify epic details, e.g., into components UI, Data, ML, API layer, etc. These classifications are also assigned a weightage that can reflect the effort associated in that component class.

For example, epic details can include a statement A, like: “I want to accurately forecast costs with four or more data points”. Another part of the story can include acceptance criteria B: “I know I will be done when . . . costs are forecasted with one or more data points” another part of the story can include assumptions C: “The model refresh is appropriate for the limited data in daily/weekly/monthly analysis”, and “The model refresh is appropriate for only 4 months of data”. In this example, the multilabel classifier 222 classifies the statement A as UI with a weight of 0.41, classifies the acceptance criteria as Data with a weightage of 0.15 and classifies the assumptions as ML with a weightage of 0.38. The weightage represents the effort needed to introduce the feature in that component class. The classification and weightage applied by the multilabel classifier 222 can be in accordance with epic detail data and machine learning techniques.

Text segmenter 223 segments text, e.g., in related epic records, into respective component categories, e.g., Data, UI, ML, API layer. The text segmenter 223 analyzes blocks of text in these epic records and assigns the text to the components, e.g., Data, UI, ML, API layer. It is noted that the component categories are the categories that will be impacted by the feature change. So, e.g., a feature change of adding a virtual machine power on/off switch can impact the user interface (UI), Data, API layer, etc.

Next, the action classifier 224 evaluates the segmented text to determine what action is being proposed and classifies the action, e.g., the statement A is classified as “update” based on the text syntax evaluated by the action classifier 224, the acceptance criteria B is evaluated as “add”, and the assumptions C is evaluated as “replace”. Along with the actions (update, add, replace) and the multilabel and weightage (UI with a weight of 0.41, Data with a weightage of 0.15 and ML with a weightage of 0.38) for statement A, acceptance criteria B and assumptions C, the complexity classifier 227 is invoked to determine the complexity of each portion. In this example, the statement A is determined to have a low complexity, the acceptance criteria B is determined to have medium complexity and the assumptions C are determined to have medium complexity.

The complexity and actions are then employed by the effort regressor 225, which can include ML based regression, to provide an estimate based on historical information about the amount of effort needed for each component, e.g., data, API layer, UI, ML.

The effort from the effort regressor 225 and similar epics of the similar epics matcher 228 are employed by the interval estimator 226 to break down each component or portion of the task to estimate the amount of effort, in time, each portion would need. The interval estimator 226 can employ statistical data from past projects through the similar epics matcher 228 to determine an effort interval (e.g., range).

The similar epics matcher 228 provides similar epics to the release estimator 230 which returns an amount of time in weeks/sprints/quarters for feature release of the product or feature being considered for each component of the feature.

Throughout the process, NFR store and detector 221 captures all nonfunctional requirements for the new feature. This data is incorporated into the process as impediments to the process. Nonfunctional requirements are considered by the effort regressor 225 and the similar epics matcher 228 to estimate based on the complexity and similar epics (from similar epics matcher 228) the cost in effort of the nonfunctional requirements. The release estimator 230 employs timings from NFRs or other requirements as provided by the timer 231 and similar epics matcher 228 to estimate a release date for the new feature.

As a result, scalable and cost-effective solutions for offerings can be provided for a large and diverse set of customers with rapid innovation and changes in the marketplace and competitive landscape. Automation is provided in accordance with embodiments of the present invention to overcome manual and subjective feature request attempts at analysis and prioritization. The present embodiments provide a data driven approach to reduce the elapsed time and skill requirements in the initial sizing and analysis of a feature requirement, and further reduce duplication of feature and functions across multiple offerings and products by awareness and discovery of existing features and components.

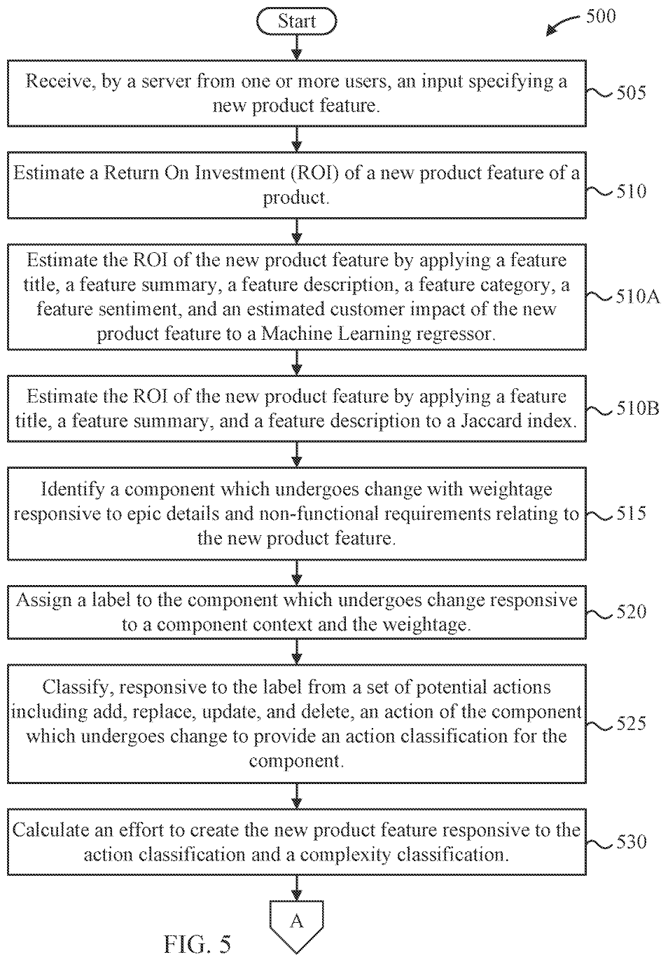

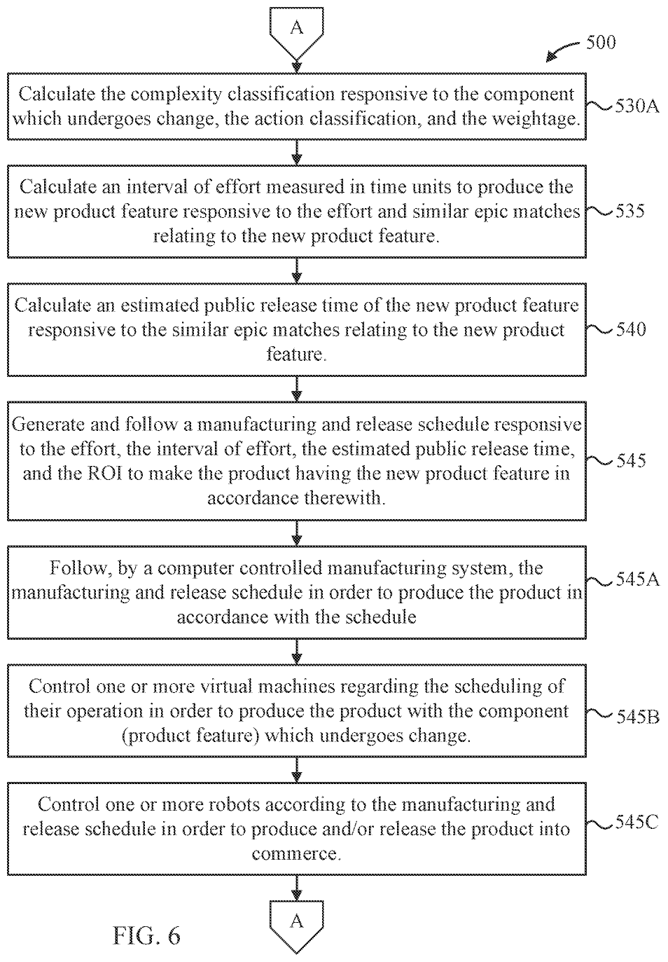

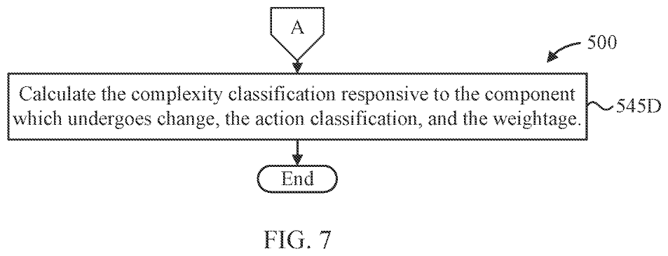

FIGS. 5-7 are flow diagrams showing an exemplary method 500, in accordance with an embodiment of the present invention.

At block 505, receive, by a server from one or more users, an input specifying a new product feature.

At block 510, estimate a Return On Investment (ROI) of a new product feature of a product.

In an embodiment, block 510 can include one or more of blocks 510A and 510B.

In block 510A, estimate the ROI of the new product feature by applying a feature title, a feature summary, a feature description, a feature category, a feature sentiment, and an estimated customer impact of the new product feature to a Machine Learning (ML) regressor.

In block 510B, estimate the ROI of the new product feature by applying a feature title, a feature summary, and a feature description to a Jaccard index. The Jaccard index estimation is particularly useful when less than all of the epic details are available. For example, if only title, a feature summary, and a feature description are available.

At block 515, identify a component which undergoes change with weightage responsive to epic details and non-functional requirements relating to the new product feature.

At block 520, assign a label to the component which undergoes change responsive to a component context and the weightage.

At block 525, classify, responsive to the label from a set of potential actions including action types (e.g., add, replace, update, and delete), an action of the component which undergoes change to provide an action classification for the component.

At block 530, calculate an effort to create the new product feature responsive to the action classification and a complexity classification.

In an embodiment, block 530 can include block 530A.

In block 530A, calculate the complexity classification responsive to the component which undergoes change, the action classification, and the weightage.

At block 535, calculate an interval of effort measured in time units to produce the new product feature responsive to the effort and similar epic matches relating to the new product feature.

At block 540, calculate an estimated public release time of the new product feature responsive to the similar epic matches relating to the new product feature.

At block 545, generate and follow a manufacturing and release schedule responsive to the effort, the interval of effort, the estimated public release time, and the ROI to make the product having the new product feature in accordance therewith.

At block 545A, follow, by a computer-controlled manufacturing system, the manufacturing and release schedule in order to produce the product in accordance with the schedule.

At block 545B, control one or more virtual machines regarding the scheduling of their operation in order to produce the product with the component (product feature) which undergoes change.

At block 545C, control one or more robots or other manufacturing equipment according to the manufacturing and release schedule in order to produce and/or release the product into commerce.

At block 545D, in the case of multiple features to be changed/released, use ROI to prioritize the features such that they are made and released in order of highest priority (highest ROI) to lowest priority (lowest ROI).

A further description of the elements performing the steps of method 500 and their operation will now be given in accordance with illustrative embodiments.

The effort estimator calculates how much effort goes into a new product feature so that the product management team can prioritize the feature.

The NFR store and detector 221 takes epic details along with customer information such as region, type, size, contract and industry, converts all these features into a feature vector representation that is fed as input to the similar epic matcher 228 (using, e.g., ML regression) which then outputs non-functional requirements from similar epics. Once given epic details, topic modelling is applied and returns non-functional requirements from a given epic, the union of the outputs from the similar epic ML matcher and topic modelling will be the non-functional requirements for the given new feature.

The multilabel classifier and weightage element 222 takes epic details along with a non-functional requirement documents as input. The epic details can include the title, a description, and a summary of a new feature. The non-functional requirement documents can include the labels for a new feature stating whether this new feature needs any security, sustainability, scalability, etc. and this textual information is converted into a feature vector representation. This feature vector representation is fed as an input to the multilabel classifier 222 to identify what are the different components that undergo a change for the given epic along with weightage examples for ML, UI, data and API components. Since it is a multilabel classifier, for a given input, the multilabel classifier outputs more than one label, e.g., the labels can have ML, UI, data and API components.

The output from multilabel classifier 222 is the target for the text segmenter 223 so if the multilabel classifier 222 identifies three components that undergo a change, then the text segmenter 223 will classify given epic description into three different groups so that each group describes a particular component.

The segmented text along with the class label is fed as input to the action classifier 224 where a given portion of the text will be converted into the feature vector representation and then the action classifier 224 applies classification methods to classify whether a given text segment belongs to either add, delete, update, or replace. In some embodiments, classification can include other categories or combinations of these categories.

The complexity classifier 227 takes a segmented component and its label along with an action and associated weightage for the given component as an input. The complexity classifier 227 takes a historical complexity and component and their weightage and tries to create a tree-based structure based on each and every component weightage. The complexity classifier 227 will try to segment a given component and its weightage along with action into a classification of either low, medium, or high. For instance, if the component is a ML component and the action is update, and the weightage is 40%, then depending on the historical components tree structure that it builds, it classifies the given component complexity into low, medium, or high.

The effort regressor 225 takes input from the complexity classifier 227 along with epic details and applies traditional ML regression techniques like artificial neural networks or a Gradient Boosting Decision Tree regressor or a k nearest neighbors (KNN), etc., to return the number of hours that it takes to add the relevant component to the product.

The similar epics matcher 228 takes the current epic and identifies what are the similar epics which are closer to the current one and returns all those epics. The underlying algorithm that is employed can include ML driven similarity detection methodologies for textual data.

The interval estimator 226 takes input from the effort regressor 225, which returns the amount of effort each and every component takes along with components efforts of similar epics matcher and returns the interval estimation of the amount of time in time units that each and every component takes in order to deliver the product with the component or feature.

The feature release estimator 230 estimates in time units how long it will take to deliver a product with a component undergoing change. The feature release estimator 230 takes given epic details as input and passes them through the similar epics matcher 228 and returns similar epics. Using the similar epics, the feature release estimator 230 will identify any component dependencies while delivering similar epics in consideration of any blockers (e.g., blockers (time) can be obtained by using raised defects and its associated efforts in hours to close those defects) and/or approvals (new instance spin up, security, etc.) for similar epics, and estimates a count in time units.

FIG. 8 is a block diagram showing an exemplary first method 800 for estimating a ROI of a feature, in accordance with an embodiment of the present invention.

The method 800 involves inputting the following into a Machine Learning (ML) regressor 877 in order to obtain a Return on Investment (ROI) 899 of a feature: title 801; summary 802; description 803; category 804; sentiment of feature 805; and customer impact 806. FIG. 8 uses epic information, e.g., title 801; summary 802; description 803; category 804; sentiment of feature 805; and customer impact 806 as input to the ML regressor 877, which employs machine learning to determine ROI 899 for a given scenario (input).

In this example, a regression method is employed for understanding the relationship between the features and outcome (ROI). Outcomes can then be predicted once this relationship has been estimated. Regression predicts continuous outcomes using predictive modelling, which employs stored outcome data and can involve plotting a best fit line through the data points. The distance between each point and the line is minimized to achieve the best fit line. Other regression techniques can also be employed. The epic data for a given feature is employed by regression to derive ROI 899 for the feature.

FIG. 9 is a block diagram showing an exemplary second method 900 for estimating a Return on Investment (ROI) 999 of a feature, in accordance with an embodiment of the present invention.

The method 900 involves inputting the following into a Jaccard similarity index (Jaccard index, in short) 950 in an ML model, e.g., KNN, in order to obtain a ROI of a feature: title 901; summary 902; and description 903. The Jaccard index estimation is particularly useful when less than all of the epic details are available. For example, if only some of the epic details are available, e.g., title, a feature summary, and a feature description or other subset of the epic details.

In this embodiment, epic information is stored in set 994, e.g., title 901; summary 902; and description 903 is employed as input and compared to existing ROIs in storage set 995. The existing ROIs include similar characteristics to set 994. The Jaccard similarity index 950 (sometimes called the Jaccard similarity coefficient) is computed and compares members for the two sets 994 and 995 to see which members are shared and which are distinct. The Jaccard similarity index is a measure of similarity for the two sets of data, with a range from 0% to 100%. The higher the percentage, the more similar the two populations. ROI 999 can be derived from this process.

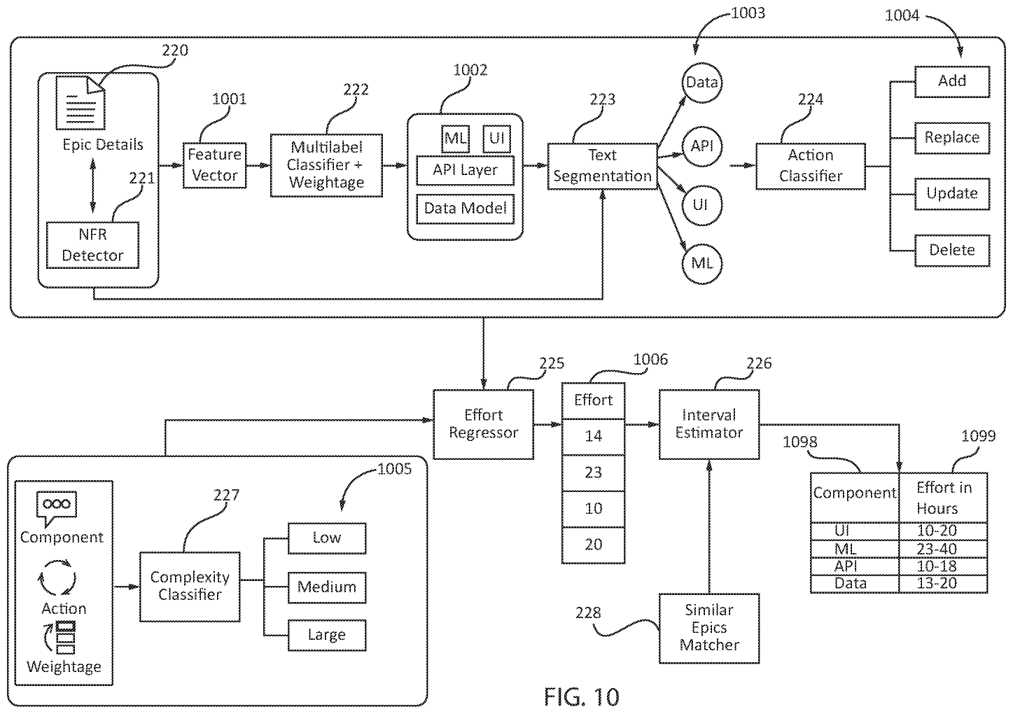

FIG. 10 is a block diagram further showing the effort regressor 225 of FIG. 3, in accordance with an embodiment of the present invention.

The epic details store 220 and NFR data store 221 are used to calculate a feature vector 1001 that is input to the multilabel classifier and weightage element 222, which outputs a label(s) 1002 such as, for example, but not limited to, ML (Machine Learning), UI (User Interface), API layer (Application Programming Interface) layer, and data model. The label(s) 1002 is provided to the text segmenter 223 which segments the input label to output a representative label 1003 (e.g., ML, UX, API, data) to the action classifier 224. The action classifier 224 outputs an action classification 1004. In an embodiment, the action classification 1004 is selected from: add; replace; update; and delete. Of course, other actions can also be used, in accordance with embodiments of the present invention.

The component which undergoes change, the action classification, and the weightage are input to the complexity classifier 227 which outputs a complexity classification 1005 (e.g., low, medium, high, etc.).

The complexity classification 1005 and the action classification 1004 are provided to the effort regressor 225, which outputs an effort level 1006 (e.g., 1-10, 1-100, 1-1000, 0.01-1, etc.). The effort level 1006 from the effort regressor 225 and similar epics from the similar epics matcher 228 are provided to the interval estimator 226 which outputs a component which undergoes change 1098 and an effort 1099 measured in hours.

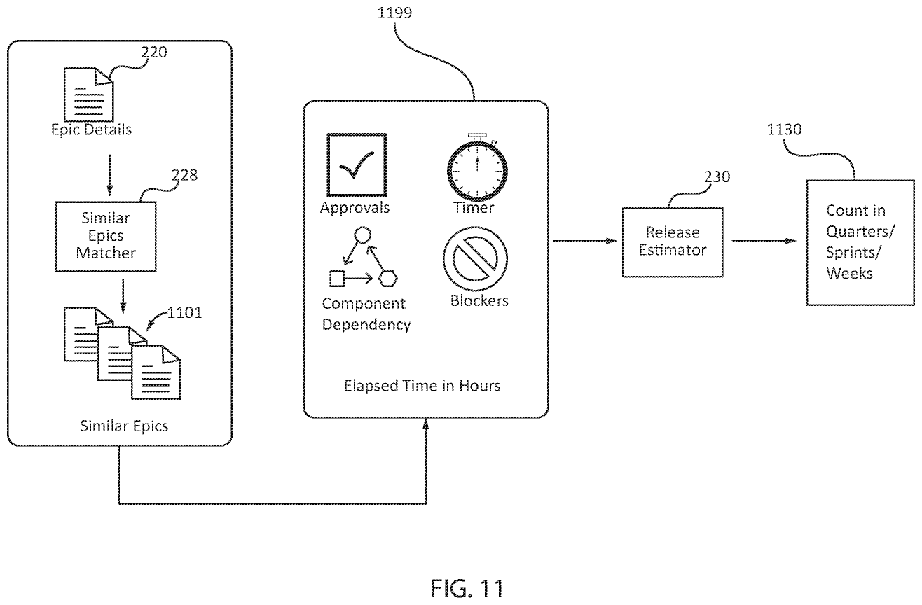

FIG. 11 is a block diagram further showing the release estimator 230 of FIG. 4, in accordance with an embodiment of the present invention.

The feature release estimator 230 estimates a count 1130, e.g., how many weeks/sprints/quarters/etc. a given feature takes in order to be delivered into the product. The feature release estimator 230 takes given epic details as an input 1199 and passes them through similar epics matcher 228, which returns similar epics 1101. Input 1199 can include delays associated with getting approvals, component dependencies (which can create delays waiting for other components or issues to be resolved), timing restrictions (e.g., personnel issues, shipping issues, etc.) and blockers (anything that stops or slows down the delivery of a product) or any other delay. Using the similar epics, similar epics matcher 228 will try to identify whether any component dependency exists while delivering similar epics and will also determine whether any blockers are present (blockers are obtained by using raised defects and their associated efforts (in hours) to close those defects). If there were any approvals needed or identified (e.g., new instance spin up, security, etc.) for similar epics, the similar epics matcher 228 takes such information and uses this information to estimate a count in time units.

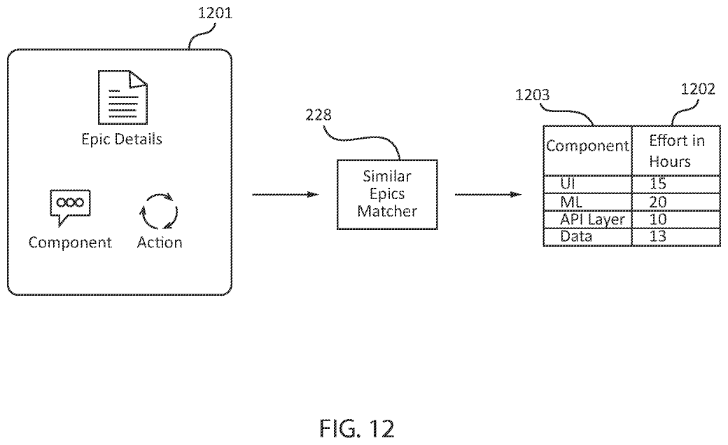

FIG. 12 is a block diagram further showing the similar epics matcher 228 of FIG. 3, in accordance with an embodiment of the present invention.

The similar epics matcher 228 receives inputs 1201 including epic details, an identification of the components (e.g., UI) which undergo change, and an action classification (e.g., add) relating to an action for the components 1203 which undergo change, and output efforts 1202 in units of time for each component which undergoes change. The similar epics matcher 228 can output the component or components 1203 and their associated output efforts 1202 in any usable format.

FIG. 13 is a block diagram showing Non-Functional Requirement (NFR) detection 1300, in accordance with an embodiment of the present invention.

A similar epics machine learning component 1302 inputs epic details 1301 and outputs non-functional requirements 1303. The input epic details can include, but are not limited to, one or more contracts, one or more industry standards, one or more component types and specifications, one or more regions (of manufacture and/or release), and one or more component or product sizes. The non-functional requirements 1303 can include scalability, reliability, regulatory, maintainability, usability, interoperability, and environmental details.

A topic or topics modeling component 1310 inputs epic details 1301 and outputs non-functional requirements 1311. The non-functional requirements 1311 can include regulatory, maintainability, serviceability, utility, security, manageability, and data integrity.

The union of the non-functional requirements 1303 and the non-functional requirements 1311 is calculated. Theis results in the output of the non-functional requirements 1330, which are then stored in NFR data store 221 (FIG. 3).

FIG. 14 is a block diagram showing an exemplary environment 1400 to which the present invention can be applied, in accordance with an embodiment of the present invention.

The environment 1400 includes an AI driven estimation system 1410 and a controlled manufacturing system 1420. The AI driven estimation system 1410 and the controlled manufacturing system 1420 are configured to enable communications therebetween. For example, transceivers and/or other types of communication devices including wireless, wired, and combinations thereof can be used. In an embodiment, communication between the AI driven estimation system 1410 and the controlled system 1420 can be performed over one or more networks, collectively denoted by the figure reference numeral 1430. The communication can include, but is not limited to, ROI estimates and related information from the AI driven estimation system 1410, which can operate as a multi-step-ahead forecasting system. Related information can include a manufacturing and release schedule 1422 and the metrics from which the schedule was determined. The AI driven estimation system 1410 estimates ROI and related information in order to determine a manufacturing and release schedule 1422 that is followed by the controlled manufacturing system 1420.

In an embodiment, manufacturing system 1420 can include one or more robots 1424 that are controlled by instructions formulated responsive to the manufacturing and release schedule 1422 in order to timely and correctly produce a new product feature. In other embodiments, manufacturing system 1420 can include one or more virtual machines (VMs) 1426 that are controlled by instructions formulated responsive to the manufacturing and release schedule 1422 in order to timely and correctly produce a new product feature.

In an embodiment, the AI driven estimation system 1410 can be implemented as a node in a cloud-computing arrangement. In an embodiment, a single AI driven estimation system 1410 can be assigned to a single controlled system or to multiple controlled systems e.g., different robots in an assembly line, and so forth. These and other configurations of the elements of environment 1400 can be determined in accordance with the teachings of the present invention provided herein.

The AI driven estimation system 1410 can be employed as a service tool for decision making. System 1410 determines scheduling impacts for feature changes, deletions, additions, while considering nonfunction requirements, functions requirements, assumptions, complexity and many other constraints. System 1410 creates a comprehensive consideration platform to assist in making feature changes in software systems or any other system that could be impacted by the addition of a new of changes feature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as SMALLTALK, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed. Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A computer-implemented method for product feature release, comprising:
estimating a Return On Investment (ROI) of a new product feature of a product;
identifying a component of the product which undergoes change with weightage responsive to epic details and non-functional requirements relating to the new product feature;
classifying, from a set of potential actions including action types, an action of the component to provide an action classification for the component;
calculating an effort to create the new product feature responsive to the action classification and a complexity classification determined from at least the weightage;
calculating an interval of effort measured in time units to produce the new product feature responsive to the effort and similar epic matches relating to the new product feature;
calculating an estimated public release time of the new product feature responsive to the similar epic matches relating to the new product feature; and
generating and following a manufacturing and release schedule responsive to the effort, the interval of effort, the estimated public release time, and the ROI to make the product having the new product feature in accordance therewith.

2. The computer-implemented method of claim 1, wherein the complexity classification is selected from the group consisting of low, medium, and high.

3. The computer-implemented method of claim 1, wherein estimating the ROI of the new product feature comprises applying a feature title, a feature summary, a feature description, a feature category, a feature sentiment, and an estimated customer impact of the new product feature to a Machine Learning regressor.

4. The computer-implemented method of claim 1, wherein the complexity classification is determined responsive to the component which undergoes change, the action classification, and the weightage.

5. The computer-implemented method of claim 1, assigning a label to the component responsive to a component context and the weightage, and wherein the action is classified responsive to the label.

6. The computer-implemented method of claim 1, wherein the component which undergoes change is selected from the group consisting of a machine learning process, a user interface, an application programming interface layer, and a data model.

7. The computer-implemented method of claim 1, further comprising segmenting a text classification of the component which undergoes change responsive to a component label and the weightage.

8. The computer-implemented method of claim 1, wherein the estimated public release time is further responsive to component dependencies with respect to the component which undergoes change relative to other components of the product.

9. The computer-implemented method of claim 1, further comprising controlling one or more robots according to the manufacturing and release schedule.

10. The computer-implemented method of claim 1, wherein the method is applied to multiple features which undergo change for the product, and the method further comprises prioritizing a manufacturing time and a release time of each the multiple features in an order based on highest ROI to lowest ROI.

11. A computer program product for product feature release, the computer program product comprising a computer readable storage medium having program instructions embodied therewith, the program instructions executable by a computer to cause the computer to perform a method comprising:
estimating, by a hardware processor of the computer, a Return On Investment (ROI) of a new product feature of a product;
identifying, by the hardware processor, a component of the product which undergoes change with weightage responsive to epic details and non-functional requirements relating to the new product feature;
classifying, by the hardware processor from a set of potential actions including action types, an action of the component to provide an action classification for the component; and
calculating, by the hardware processor, an effort to create the new product feature responsive to the action classification and a complexity classification determined from at least the weightage;
calculating, by the hardware processor, an interval of effort measured in time units to produce the new product feature responsive to the effort and similar epic matches relating to the new product feature;
calculating, by the hardware processor, an estimated public release time of the new product feature responsive to the similar epic matches relating to the new product feature; and
generating and following, by a manufacturing and product release system, a manufacturing and release schedule responsive to the effort, the interval of effort, the estimated public release time, and the ROI to make the product having the new product feature in accordance therewith.

12. The computer program product of claim 11, wherein the complexity classification is selected from the group consisting of low, medium, and high.

13. The computer program product of claim 11, wherein estimating the ROI of the new product feature comprises applying a feature title, a feature summary, a feature description, a feature category, a feature sentiment, and an estimated customer impact of the new product feature to a Machine Learning regressor.

14. The computer program product of claim 11, wherein the complexity classification is determined responsive to the component which undergoes change, the action classification, and the weightage.

15. The computer program product of claim 11, assigning a label to the component responsive to a component context and the weightage, and wherein the action is classified responsive to the label.

16. The computer program product of claim 11, wherein the component which undergoes change is selected from the group consisting of a machine learning process, a user interface, an application programming interface layer, and a data model.

17. The computer program product of claim 11, further comprising segmenting a text classification of the component which undergoes change responsive to a component label and the weightage.

18. The computer program product of claim 11, wherein the estimated public release time is further responsive to component dependencies with respect to the component which undergoes change relative to other components of the product.

19. The computer program product of claim 11, further comprising controlling one or more robots according to the manufacturing and release schedule.

20. A computer processing system for product feature release, comprising:
a memory device for storing program code; and
a hardware processor operatively coupled to the memory device for running the program code to:
estimate a Return On Investment (ROI) of a new product feature of a product;
identify a component of the product which undergoes change with weightage responsive to epic details and non-functional requirements relating to the new product feature;
classify, from a set of potential actions including action types, an action of the component to provide an action classification for the component;
calculate an effort to create the new product feature responsive to the action classification and a complexity classification determined from at least the weightage;
calculate an interval of effort measured in time units to produce the new product feature responsive to the effort and similar epic matches relating to the new product feature;
calculate an estimated public release time of the new product feature responsive to the similar epic matches relating to the new product feature; and
generate and follow a manufacturing and release schedule responsive to the effort, the interval of effort, the estimated public release time, and the ROI to make the product having the new product feature in accordance therewith.
